(19) United States
(12) Patent Application Publication
(10) Pub. No.: US 2015/0084473 A1
(43) Pub. Date: Mar. 26, 2015

(54) INDUCTION MOTOR AND MANUFACTURING METHOD THEREOF

(71) Applicant: KABUSHIKI KAISHA TOSHIBA, Minato-ku (JP)

(72) Inventor: Taizo TOMIOKA, Isogo-ku (JP)

(73) Assignee: KABUSHIKI KAISHA TOSHIBA, Minato-ku (JP)

(21) Appl. No.: 14/208,587

(22) Filed: Mar. 13, 2014

(30) Foreign Application Priority Data
Sep. 20, 2013 (JP) 2013-194928

(51) Int. Cl. H02K 17/16; H02K 15/00

(52) U.S. Cl. CPC H02K 17/165; H02K 15/0012
USPC 310/211; 29/598

(57) ABSTRACT

An induction motor includes multiple conductor bars buried and disposed in a rotor core in a circumferential direction, and end rings joined with the multiple conductor bars so as to cause respective both ends thereof to be electrically conducted. Each conductor bar includes a first bar-shape metal portion, and two second metal portions joined with both ends thereof. The second metal portion is formed in a solid block shape. The first and second metal portions are joined with each other by friction stir welding or friction welding.

### CROSS-REFERENCE TO RELATED APPLICATIONS

This application is based upon and claims the benefit of priority from Japan Patent Application No. 2013-194928, filed on Sep. 20, 2013, the entire contents of which are incorporated herein by reference.

### FIELD

Embodiments described herein relate to an induction motor including a cage rotor, and a manufacturing method thereof.

### BACKGROUND

Cage-type three-phase induction motor operates with a three-phase AC current, and needs no rectifier and brush, etc. Hence, in comparison with motors of other types like DC motors, the structure is simple and the product lifetime is long. Accordingly, such motors are widely applied as a power source of industrial apparatuses, such as a pump, a fan, and a robot.

The rotor of such an induction motor includes an iron core in a cylindrical shape, a cage, and a rotation shaft. The cage includes a conductor bar buried in slots arranged regularly in the outer circumference of the iron core, and end rings disposed at both ends of the iron core and causing the conductor bar short-circuited.

In rotors of an induction motor, the conductor bar and the end rings are normally formed integrally with each other by aluminum die-casting to form a conductor cage. According to this scheme, however, when voids are formed in the conductor bar and the end rings, solidification and shrinkage may occur. In order to address such a technical problem, there is known a method of forming the conductor bar and the end rings separately using aluminum or an aluminum alloy, and joining the conductor bar and the end rings by friction stir welding.

In addition, when the conductor bar and end rings of the rotor of an induction motor are formed of different metals, the conductor bar formed of any one of copper and a copper alloy is inserted in an iron core having a length in the axial direction shorter than the conductor bar. Next, a protruding part of the conductor bar from the iron core is inserted in aluminum or the like in a semi-solidified condition, and those are let solidified to form end rings, thereby forming the conductor bar and the end rings integrally.

### BRIEF DESCRIPTION OF THE DRAWINGS

FIG. 1 is a cross-sectional view illustrating a structure of an induction motor according to a first embodiment;

FIG. 2 is a perspective view illustrating a structure of a rotor according to the first embodiment;

FIG. 3 is a cross-sectional view illustrating a structure of the rotor according to the first embodiment;

FIG. 4 is a cross-sectional view illustrating a structure of a conductor bar according to the first embodiment;

FIG. 5 is a perspective view illustrating a first joining tool to join a first metal portion and a second metal portion;

FIGS. 6A and 6B are diagrams illustrating a manufacturing process of the conductor bar according to the first embodiment;

FIGS. 7A to 7F are diagrams illustrating a joining process of the conductor bar with end rings according to the first embodiment;

FIG. 8 is a perspective view illustrating a shape of the rotor according to the first embodiment before a rotation shaft is inserted;

FIG. 9 is a perspective view illustrating a structure of a rotor of an induction motor according to a second embodiment;

FIG. 10 is a cross-sectional view illustrating a structure of the rotor according to the second embodiment; and

FIG. 11 is a cross-sectional view illustrating a rotor core and a conductor bar according to the second embodiment when the conductor bar and end rings are joined.

### DETAILED DESCRIPTION

The present disclosure provides an induction motor that includes a conductor cage. The conductor cage includes a plurality of conductor bars buried and disposed in a rotor core in a circumferential direction, and end rings joined with the plurality of conductor bars so as to cause respective both ends thereof to be electrically conducted, in which: each conductor bar includes a first bar-shape metal portion, and two second metal portions joined with both ends of the first metal portion; and the second metal portion is formed in a block shape.

The present disclosure also provides a manufacturing method of an induction motor, the method includes: burring and disposing a plurality of conductor bars in a rotor core in a circumferential direction, each conductor bar including a first bar-shape metal portion, and a second metal portion joined with an end of the first metal portion and formed in a block shape; and assembling a conductor cage by joining end rings with the plurality of conductor bars so as to cause respective both ends thereof to be electrically conducted.

### First Embodiment

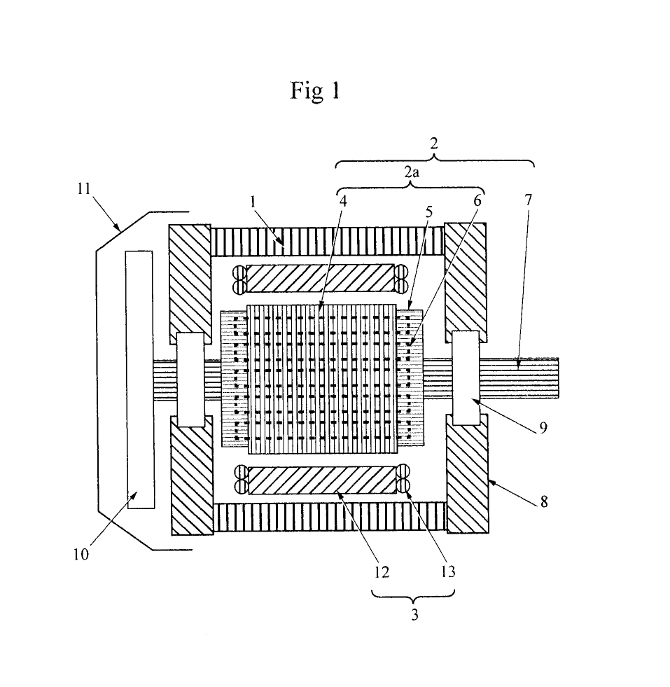

An explanation will be given below of an induction motor and a manufacturing method thereof according to this embodiment with reference to FIGS. 1 to 8. The same portion throughout the respective figures will be denoted by the same reference numeral to omit a duplicated explanation.

An induction motor of this embodiment has multiple conductor bars each disposed around an iron core and buried therein, and, formed of a first metal portion in a bar shape, and second metal portions in a block shape joined with both ends of the first metal portion. In addition, when the metals forming the second metal portions are joined with end rings 5, the respective conductor bars are electrically short-circuited through the end rings.

(1. Structure)

(1-1. Whole Structure)

FIG. 1 is a cross-sectional view illustrating a structure of an induction motor according to an embodiment of the present disclosure. The induction motor of this embodiment has a rotor 2 and a stator 3 retained in a frame 1.

The frame 1 is a cylindrical member formed by, for example, forging an iron-based material, and has openings at both ends attached with brackets 8 in a disc shape each having a bearing 9 at the center thereof. Unillustrated cooling fins are provided around the outer periphery of the frame 1.

The rotor 2 includes a rotor core 4 having magnetic steel sheets laminated together and provided with a hole to dispose the rotation shaft 7 at the center, a conductor cage 2a disposed in the rotor core 4 and having the multiple conductor bars 6 with both ends joined with the end rings 5 so as to be electrically short-circuited therewith, and the rotation shaft 7. The rotor core 4 has a diameter that is 90 mm, and has a length in the axial direction which is 120 mm. The shape of the hole of the rotor core 4 to dispose the rotation shaft 7 can be selected arbitrary in accordance with the rotation shaft 7, and can be a circular hole, a rectangular hole, and the like.

The rotation shaft 7 is held by the two bearings 9 held by the respective brackets 8. The one end of the rotation shaft 7 is attached with cooling blades 10 which suction air from the exterior of a cover 11 when the induction motor is actuated, feed winds to the cooling fins of the frame 1, thereby cooling the induction motor.

The stator 3 is disposed outside the rotor core 4. The stator 3 includes a stator iron core 12 having magnetic steel sheets laminated together, and coils 13. The coil 13 may be wound around the stator iron core 12 or a coil separately manufactured may be attached to the stator core 12.

(1-2. Structure of Rotor)

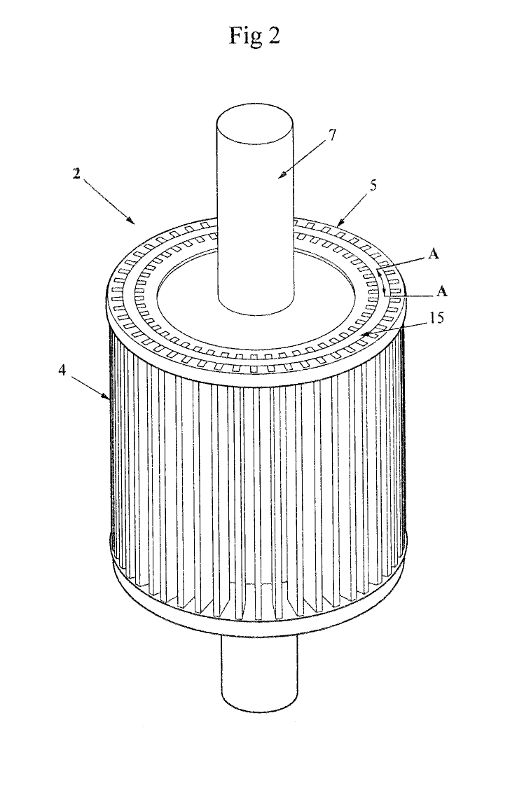

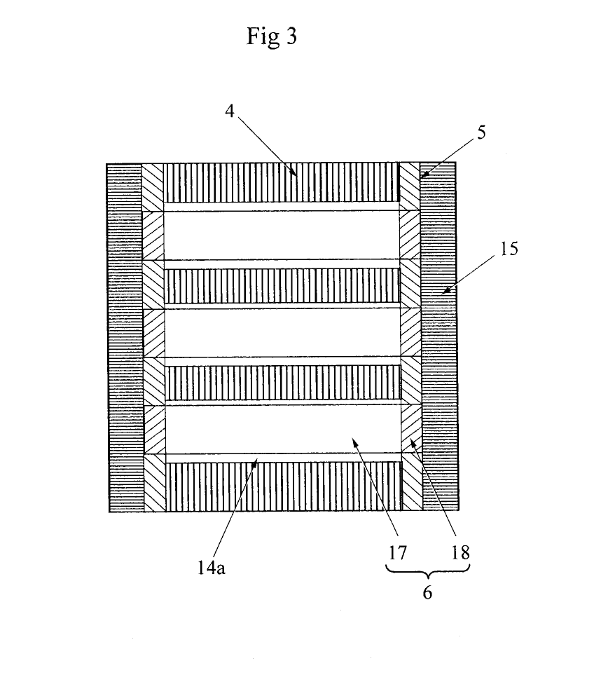

FIG. 2 is a perspective view illustrating a structure of the rotor 2 of the induction motor, and FIG. 3 is a cross-sectional view illustrating the structure of the rotor of the induction motor.

The rotor core 4 is a cylindrical member having cylindrical magnetic steel sheets laminated together and provided with a hole to dispose the rotation shaft 7 at the center. In addition, multiple slots 14a are formed in the outer circumference of the rotor core 4 in the axial direction. The multiple slots 14a, e.g., 44 slots 14a are formed at a predetermined pitch in the circumferential direction.

The end rings 5 are provided at both ends of the rotor core 4, and are ring members joining both ends of the conductor bar 6. When respective ends of the conductor bars 6 are joined by the end ring 5, the multiple conductor bars 6 are electrically short-circuited. The end ring 5 is provided with slots 14b corresponding to the respective slots 14a when disposed at each of both ends of the rotor core 4. That is, when the rotor core 4 and the end rings 5 are assembled, the slot 14a and the slot 14b are in communication with each other, thereby forming a slot.

It is desirable that the metal forming the end ring 5 should be a lightweight metal with a low electrical resistance. More specifically, aluminum or an aluminum alloy is suitable, and in this embodiment, aluminum is adopted.

The conductor bar 6 is a bar-shape member retained in the slots 14a and 14b provided in the rotor core 4 and the end rings 5, respectively. The conductor bar 6 retained in the respective slots 14a and 14b is joined with the end rings 5 at both ends, and thus the whole conductor bars 6 are electrically short-circuited.

When the end rings 5 and the conductor bars 6 are joined through friction stir welding to be discussed later, as illustrated in FIG. 3, a friction stir welding area 15 is formed outside the end rings 5 (the side that does not contact the rotor core 4). A portion not subjected to a plastic flow by friction stir welding is left at the rotor core-4 side.

According to this embodiment, the length of the end ring in the axial direction of the rotor is 15 mm. In addition, a portion (friction stir welding area 15) where the end ring 5 and a part of the conductor bar 6 joined by friction stir welding is substantially 10 mm, and a portion not subjected to friction stir welding is substantially 5 mm. The friction stir welding area 15 is a portion where a joining tool to be discussed later is scanned, and thus, as illustrated in FIG. 2, the friction stir welding area 15 is formed in a ring shape that interconnects the centers of the respective ends of the conductor bars 6 in the radial direction.

(1-3. Structure of Conductor Bar)

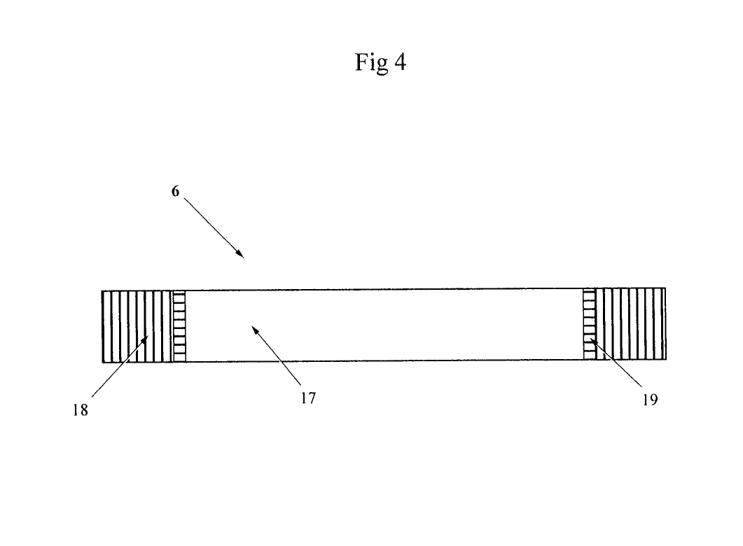

FIG. 4 is a cross-sectional view illustrating a structure of the conductor bar 6. As illustrated in FIG. 4, the conductor bar 6 includes the bar-shape first metal portion 17 occupying the major region of the center, and the two block-shape second metal portions 18 joined with both ends of the first metal portion 17. The second metal portion 18 is a solid block, and is formed in a cylindrical shape. In addition, according to this embodiment, even if slight bubbles are left in the block, it is within the meaning of solid. Still further, the second metal portion 18 may be a porous material. When the second metal portion 18 is a porous material, the second metal portion 18 can be easily softened when the end ring 5 is formed through die-casting. This improves the joining condition.

The first metal portion 17 and the second metal portion 18 can be joined by friction press joining or friction stir welding, etc. An intermetallic compound 19 is formed at an interface between the first metal portion 17 and the second metal portion 18, which functions to join the first metal portion 17 with the second metal portion 18. It is desirable that the thickness of the intermetallic compound 19 should be equal to or smaller than 2 μm in consideration of an electrical resistance and a strength at the joined portion.

The metal forming the first metal portion 17 has a low electrical resistance, and has a higher melting point than that of the metal forming the end ring 5. An example metal forming the first metal portion 17 is copper or a copper alloy, and according to this embodiment, anoxic copper is applied.

The metal forming the second metal portion 18 has a lower melting point than that of the metal forming the first metal portion 17. An example metal forming the second metal portion 18 is aluminum or an aluminum alloy, and according to this embodiment, pure aluminum like A1050 aluminum is applied.

As to the composition of the intermetallic compound 19, when the metal forming the first metal portion 17 is copper and the metal forming the second metal portion 18 is aluminum, the composition becomes CuAl₂.

(2. Manufacturing Process)

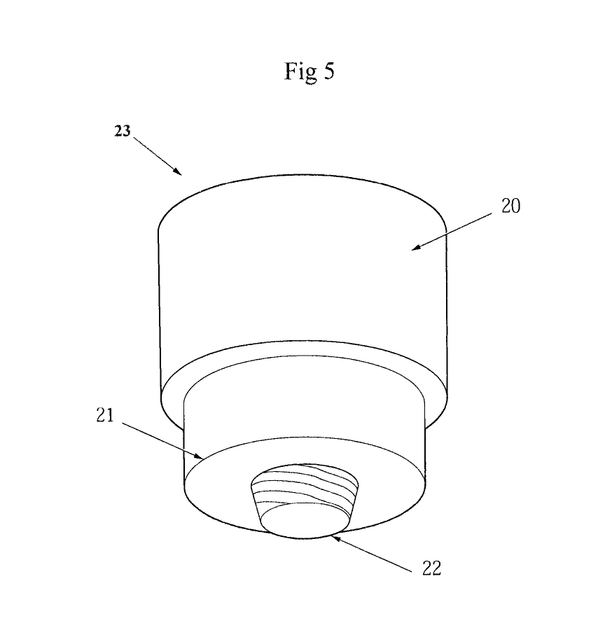

Next, an explanation will be given of a manufacturing method of the induction motor according to this embodiment with reference to FIGS. 5 to 8. In this embodiment, the induction motor is manufactured through the following processes.

(2-1. Manufacturing Process of Conductor Bar)

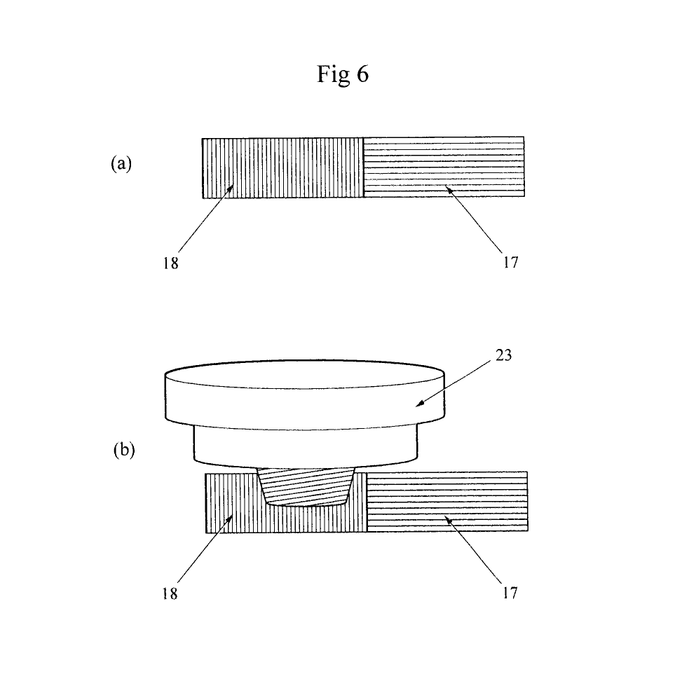

In the manufacturing process of the conductor bar 6, first, a pure aluminum block to be the second metal portion 18 is caused to abut a pair of opposing sides of an anoxic copper plate to be the first metal portion 17, and both are joined by friction stir welding. FIG. 5 is a perspective view illustrating a first joining tool to join the first metal portion 17 and the second metal portion 18 by friction stir, and FIGS. 6A and 6B are each a diagram illustrating a manufacturing process of the conductor bar 6.

As illustrated in FIG. 5, a first joining tool 23 includes a cylindrical shank 20 to be attached with a friction stir welding apparatus (unillustrated), a cylindrical shoulder 21 coaxial with the shank 20 but having a shorter diameter than the shank 20, and a conical probe pin 22 coaxial with the shank 20 and the shoulder 21. In this embodiment, the shoulder 21 has a diameter of 10 mm, the probe pin 22 has a basal-end diameter of 4 mm and a tip diameter of 3 mm, and, the probe pin 22 has a height of 1.5 mm. Threads of 0.7 mm pitch are formed in the side face of the probe pin 22.

In the manufacturing process of the conductor bar 6, as illustrated in FIG. 6A, a pure-aluminum block to be the second metal portion 18 is arranged next to the anoxic copper plate to be the first metal member 17, and is caused to abut therewith. The plate to be the first metal portion 17 has a thickness of 2.5 mm and a length of 120 mm, and the block to be the second metal portion 18 has a thickness of 2.5 mm and a length of 16 mm.

Next, with the first joining tool 23 of the friction stir welding apparatus being rotated at 2000 rpm, as illustrated in FIG. 6B, such a tool is inserted in a portion near the boundary between the second metal portion 18 and the first metal portion 17.

After the joining tool 23 is inserted, the joining tool 23 is maintained at this position, and the second metal portion 18 around the probe pin 22 is sufficiently made softened. In this embodiment, the joining tool 23 is held for 0.5 seconds to sufficiently increase the temperature of the second metal portion 18 to let the second metal portion 18 softened, and the second metal portion 18 is subjected to a plastic flow in accordance with the rotation of the joining tool 23. Subsequently, the first joining tool 23 is scanned in such a way that a distance between the outer circumference of the probe pin 22 and the boundary between the first metal portion 17 and the second metal portion 18 becomes equal to or shorter than 0.5 mm. At this time, the first joining tool 23 is tilted toward the opposite side of the scanning direction so as to hold a lifted portion of the second metal portion 18 by the shoulder 21. The second metal portion 18 subjected to a plastic flow processes the surface of the first metal portion 17, and thus the first metal portion 17 and the second metal portion 18 are joined with each other.

Such a joining is performed on the front and rear of the conductor bar 6 disposed at the pair of two sides of the first metal portion 17 by four times at a total to integrate the first metal portion 17 and the second metal portion 18 with each other. Subsequently, the surface of the joined portion is processed, and the first metal portion 17 and the second metal portion 18 integrated together are cut as a bar-shape member having a thickness of 2 mm, a width of 10 mm, and a length of 150 mm in such a way that the center portion is formed by the first metal portion 17 and both ends are formed by the second metal portion 18, thereby manufacturing the conductor bar 6. The length of the first metal portion 17 at the center of the conductor bar 6 is 120 mm, while the length of the second metal portion 18 at both ends is each 15 mm.

(2-2. Conductor Bar Joining Process)

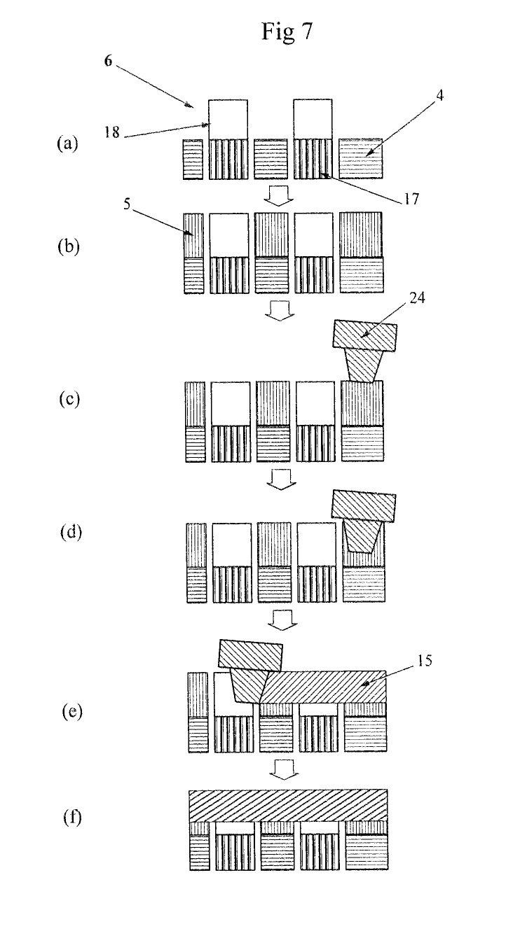

In a conductor bar joining process, the respective ends of the multiple conductor bars 6 disposed circumferentially are joined with the end ring 5 to form a cage-type rotor. FIGS. 7A to 7F are diagrams each illustrating the joining process of the conductor bars.

In the conductor bar joining process, as illustrated in FIG. 7A, the conductor bars 6 are inserted in the slots 14a of the rotor core 4. The rotor core 4 is formed by, for example, laminating 240 magnetic steel sheets each having a thickness of 0.5 mm and a diameter of 90 mm together so as to obtain a lamination thickness of 120 mm. The slots 14a are each pierced in the outer circumference of the rotor core 4 as a width of 2.1 mm and a length of 10.1 mm, and drilled along the circumferential direction in such a way that the lengthwise directions of the respective slots 14a are oriented radially at a predetermined pitch (see FIG. 2). In this case, it is mentioned that the slots 14a are pierced, but as long as a strength to hold the retained conductor bar 6 is maintained, some of the slots 14a at the outer circumference side can have a part at the outer circumference side relative to the rotor core 4 closed or opened.

Next, as illustrated in FIG. 7B, the end ring 5 is disposed in such a way that the slots 14b thereof are disposed so as to correspond to the second metal portions 18 of the protruding conductor bars 6, and engaged therewith. The end ring 5 has a thickness of 15 mm, and a diameter of 88 mm, and the slots 14b each having a width of 2.1 mm and a length of 10.1 mm so as to correspond to the respective slots 14a of the iron core are provided in the outer circumference. The end ring 5 is formed of pure aluminum A1050.

Next, the assembly including the rotor core 4, the conductor bars 6, and the end rings 5 is mounted on a jig (unillustrated) of the friction stir welding apparatus. As to the mounting to the friction stir welding apparatus, the assembly of the rotor core 4, the conductor bars 6, and the end rings 5 is aligned in the vertical direction, and downward pressure of 20 kN is applied to the outer circumference of the upper end ring 5 to set the assembly to the jig.

After the assembly is mounted on the friction stir welding apparatus, a second joining tool 24 is rotated at 1000 rpm, and as illustrated in FIG. 7C, pressure of 10 kN is applied to the end ring 5. The shape of the second joining tool 24 is similar to that of the first joining tool 23, a shoulder 21 of the second joining tool 24 has a diameter of 16 mm, a probe pin 22 thereof has a diameter of 8 mm, and the height of the probe pin 22 is 8 mm.

When the rotating second joining tool 24 is pressurized to the end ring 5, friction heat is produced between the second joining tool 24 and the end ring 5. This friction heat causes the end ring 5 to be softened, and as illustrated in FIG. 7D, the probe pin 22 of the second joining tool 24 is inserted in the end ring 5 at a speed of 30 mm/min.

Subsequently, as illustrated in FIGS. 7E and 7F, with the probe pin 22 being inserted, the second joining tool 24 is moved in the horizontal direction at a speed of 1000 mm/min for each minute to join the end ring 5 with the conductor bars 6. A joining trajectory is formed in a ring shape, has a length of 260 mm. In addition, the joining on one side can be completed within a total of substantially 30 seconds including a time for inserting the second joining tool 24 into the end ring 5 and a time for retracting the tool when the joining completes.

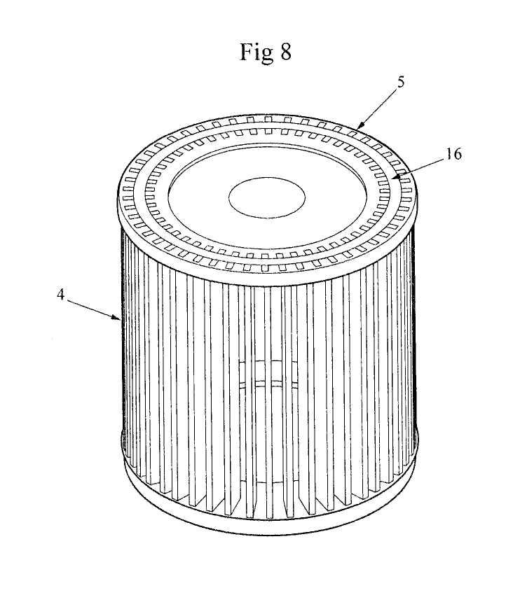

Eventually, the burr of the joined portion is eliminated by cutting, thereby finishing a cage-type rotor. FIG. 8 illustrates a shape of the rotor before the rotation shaft is inserted. Formed on the opposite face to the surface contacting the iron core 4 of the end ring 5 is an annular friction stir welding trace 16 formed by the second joining tool 24.

According to the cage-type rotor manufactured in this way, the second metal portion 18 formed of the same kind of the metal forming the end ring 5 is provided at a joined portion between the conductor bar 6 and the end ring 5. Hence, when friction stir welding is applied, the conductor bar 6 can be surely joined with the end ring 5.

In addition, according to the cage-type rotor, the length of the first metal portion 17 (120 mm) in the axial direction of the rotor is equal to or longer than the length of the slot 14a (120 mm) in the axial direction of the rotor. Accordingly, most portions of the conductor bar 6 where it is desirable to decrease an electrical resistance can be formed of the first metal portion 17 formed of the metal with an excellent electrical resistance.

Still further, according to the cage-type rotor, the metal forming the second metal portion 18 is likely to perform plastic deformation at a lower temperature than the metal forming the first metal portion 17. Hence, the necessary temperature when the end ring and the conductor bar are joined together by friction heat does not become high in comparison with a case in which the metals forming the first metal portion are subjected to friction stir welding.

(3. Advantageous Effects)

(1) According to the induction motor of this embodiment manufactured through the manufacturing method as explained above, the center of the conductor bar 6 can be formed of a metal with a low electrical resistance, while the end ring 5 can be formed of aluminum or an aluminum alloy. That is, a metal with a lower melting point than that of the metal forming the center of the conductor bar 6 is applicable for the end ring 5. Accordingly, it becomes possible to suppress a friction of the joining tool used at the time of a friction stir welding. Therefore, it becomes possible to provide an induction motor excellent in electrical performance, lightweight, and costs.

(2) In addition, the end ring 5 and the conductor bar 6 are formed of an alloy containing the similar kind or same kind of metal as a primary component. Hence, in the friction stir welding, both end ring 5 and conductor bar 6 can be substantially simultaneously made softened, stirred and integrated together. Accordingly, a joining realizing high strength and reliability can be performed.

(3) In this embodiment, the specific example was explained, but the following modifications are applicable.

(a) The second metal portion 18 and the end ring 5 are joined by friction stir welding, but friction heat may be produced between the second metal portion 18 and the end ring 5, and other joining schemes utilizing such friction heat may be applied. For example, the second metal portion 18 and the end ring 5 may be rubbed against each other at a fast speed, those may be made softened by friction heat produced at this time, and pressure may be simultaneously applied to perform friction welding on those members. In addition, a metal plug may be rotated against the end ring 5 at a fast speed, and the end ring 5, the conductor bar 6, and the metal plug may be joined by friction plug joining utilizing friction heat produced at this time.

(b) The first metal portion 17 is formed of an anoxic copper, but other metals, such as gold and silver, having a high conductivity may be applied.

(c) The second metal portion 18 is formed of pure aluminum, but other metals with a sufficiently low electrical resistance may be applied. In this case, the metal forming the end ring 5 should be a metal that permits friction stir welding with the second metal portion 18. A specific example is an alloy having a primary component that is the similar kind or same kind of metal.

(d) The rotor core 4 is formed of circular magnetic steel sheets laminated together, but an integral molding component like a powder compact core may be applicable.

(e) The length of the first metal portion 17 of the conductor bar 6 is set to be equal to the length of the slot of the rotor core 4. However, as long as a portion of the conductor bar 6 where it is desirable to decrease an electrical resistance is formed of the first metal portion 17 with an excellent electrical resistance, the length of the first metal portion 17 may be inconsistent with the length of the slot of the rotor core 4. That is, the length of the first metal portion 17 may be slightly longer or shorter than the length of the slot of the rotor core 4.

(f) In the conductor bar joining process, the first metal portion 17 and the second metal portion 18 are joined by friction stir welding, but both may be joined by friction welding. For example, according to a scheme of performing friction welding that pressurizes a copper bar member and an aluminum bar member and joins those with each other while producing friction heat to manufacture a joined member of copper and aluminum, and of cutting out the joined member to the shape of the conductor bar 6, the same advantage can be accomplished.

(g) In addition, the shape of the second metal portion 18 in this embodiment is a cylindrical shape, but as long as the shape permits a friction stir welding with the end ring 5, such a shape can be changed as needed. For example, the shape of the second metal portion 18 may be a circular cone shape having a side to be joined with the first metal portion 17 as a bottom, and the shape of the slot 14b of the end ring 5 may be a shape engageable with the circular cone first metal portion 17.

(h) Still further, according to this embodiment, a scheme of inserting the conductor bar 6 into the slot 14 of the rotor core 4 one by one is applied, but with the one end ring 5 and the respective ends of the multiple conductor bars 6 being joined with each other, after the conductor bars 6 are inserted in the respective slots 14, the respective other ends of the conductor bars 6 may be joined with the other end ring 5.

### Second Embodiment

Next, an explanation will be given of a second embodiment. This embodiment is a modification of a structure of the rotor of the first embodiment. In accordance with such a modification, the conductor bar joining process in the manufacturing process becomes different.

(1. Structure of Rotor)

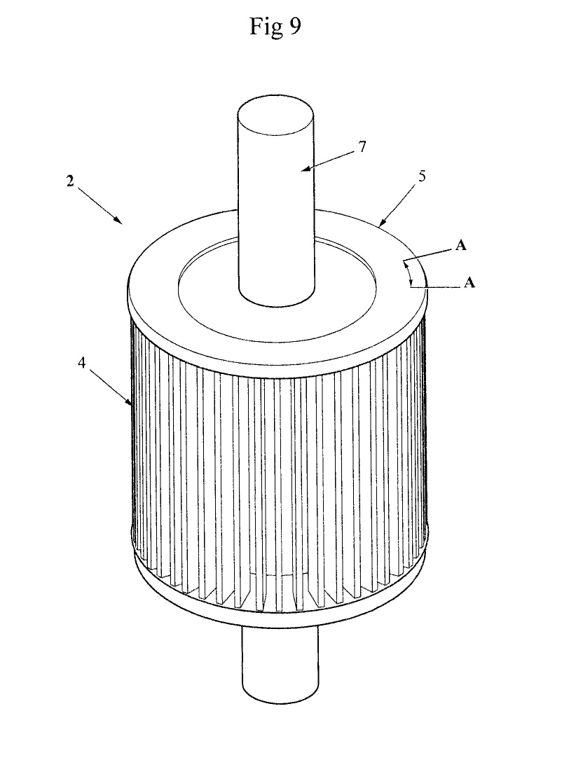

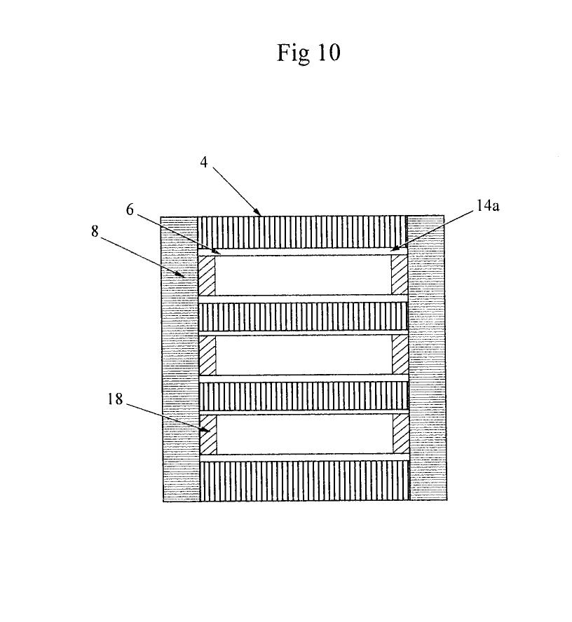

FIG. 9 is a perspective view illustrating a structure of a rotor of an induction motor according to the second embodiment, while FIG. 10 is a cross-sectional view illustrating the structure of the rotor of the induction motor.

The end rings 5 are formed by die-casting so as to be joined with both ends of the conductor bar 6, respectively.

(2. Manufacturing Process)

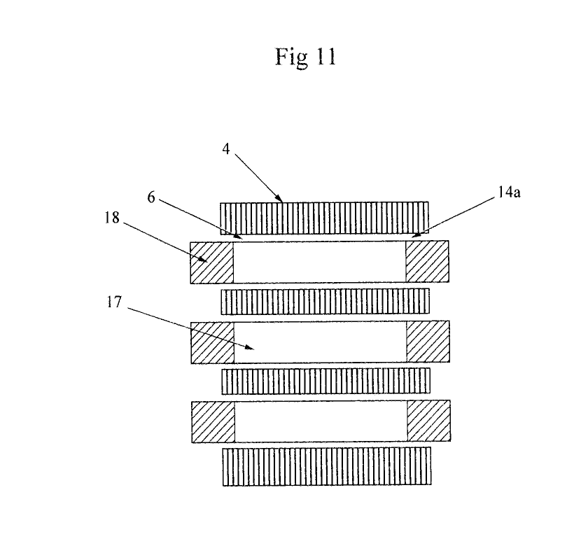

An explanation will be given of a manufacturing method of the induction motor of this embodiment with reference to FIG. 11. In this embodiment, the induction motor is manufactured through the following processes.

(2-1. Conductor Bar Joining Process)

In the conductor bar joining process of the second embodiment, the conductor bar 6 having the second metal portions 18 joined with both ends of the first metal portion 17 manufactured through the same method as that of the first embodiment is applied. Regarding the conductor bar 6 of this embodiment, the center first metal portion 17 has a length of 115 mm, and the second metal portions 18 at both ends have each 20 mm.

According to this embodiment, the metal forming the second metal portion 18 has a lower liquidus line temperature than that of the metal forming the end ring 5, and in this embodiment, A5000-series aluminum is applied. 5000-series aluminum has a lower melting point range than pure aluminum utilized as a metal forming the end ring 5 in this embodiment. That is, among A5000-series aluminum, A5005 has a melting point range from 630 to 650° C. which is lower than the melting point of pure aluminum that is 660.6° C.

(2-2. Conductor Bar Joining Process)

In the joining process of the conductor bar 6 according to this embodiment, the end ring 5 that causes the conductor bars 6 electrically short-circuited is formed by die-casting, thereby assembling a conductor cage 2a. FIG. 11 is a cross-sectional view illustrating the rotor core 4 and the conductor bar 6 in the conductor bar joining process.

In the conductor bar joining process, as illustrated in FIG. 11, the conductor bar 6 is inserted in the slot 14a of the rotor core 4, and the second metal portion 18 is caused to protrude to the exterior of the rotor core 4. The length of the rotor core 4 in the axial direction is 120 mm, and as illustrated in FIG. 11, a part of the second metal portion 18 of the conductor bar 6 is retained in the slot 14a of the rotor core 4.

Next, the rotor core 4 having the conductor bars 6 inserted therein is placed in a fixed die in an unillustrated die-cast molding die. The fixed die has voids at both ends of the rotor core 4.

Next, a movable die is moved to clamp the dies, and a molten metal to be the end ring 5 and pressurized by a plunger is poured in the voids, thereby forming the end rings 5. At this time, the molten metal to be the end ring 5 contacts the second metal portion 18, and thus the metal surface of the second metal portion 18 is melted. Hence, the end ring 5, the second metal portion 18, and further the conductor bar 6 are integrated together.

Subsequently, after the metal to be the end rings 5 is solidified, the molded piece is taken out from the dies. Thereafter, the rotation shaft is inserted in the center hole of the rotor core 4, and thus the rotor is finished.

According to the cage-type rotor manufactured in this way, the second metal portion 18 formed of a metal with a lower melting point than that of the metal forming the end ring 5 is provided at the joined portion of the conductor bar 6 with the end ring 5. Accordingly, the surface of the metal block to be the second metal portion 18 is surely melted by heat from the molten metal to be the end ring 5 and poured in the void. Therefore, when the end rings 5 are formed integrally by die-casting, the end rings 5 and the conductor bar 6 can be surely integrated together.

In addition, according to the cage-type rotor, the length of the first metal portion 17 in the axial direction of the rotor is set to be 110 mm, while the length of the slot 14a in the axial direction of the rotor is set to be 120 mm. Thus, the length of the first metal portion 17 in the axial direction of the rotor is made shorter than the length of the slot 14a of the rotor core 4 in the axial direction of the rotor. Accordingly, the joined portion between the end ring 5 and the second metal portion 18 enters the interior of the rotor core 4. Hence, shear stress applied to the joined portion between the end ring 5 and the second metal portion 18 when the cage-type rotor rotates can be reduced, suppressing a breakage of the joined portion.

(3. Advantageous Effects)

According to the induction motor of this embodiment manufactured in this way, like the first embodiment, the center of the conductor bar 6 can be a metal with a low electrical resistance, while the end ring 5 can be aluminum or an aluminum alloy. In addition, the end ring 5 and the conductor bar 6 are joined by friction stir welding of the similar kind of metals, resulting in a joining with a high reliability.

Upon making an induction motor using copper with a lower electrical resistance than that of aluminum for the material of the conductor bar, the following possibilities may exist.

When the copper-made conductor bar and the end rings are subjected to friction stir welding, the temperature of the joined copper portion in the friction stir welding is substantially 700° C. which is remarkably higher than the melting point of aluminum that is 660.4° C. Hence, it becomes inevitably necessary to form the end rings using copper, and when, in comparison with a case in which both conductor bar and end rings are formed of aluminum, the costs remarkably increase. In addition, the scanning speed of a joining tool is 1000 mm/min in the case of aluminum with a thickness of 5 mm, but becomes 200 mm/min in the case of an anoxic copper plate with a thickness of 5 mm. Hence, the productivity decreases.

Conversely, when the conductor bar is formed of copper or a copper alloy, an end of the conductor bar is inserted in aluminum or the like in a semi-solidified condition, and such aluminum is cooled to integrate the end rings, the temperature of aluminum at the time of semi-solidification is lower than the melting point of copper. Accordingly, the joining of the aluminum-made end rings with the copper-made conductor bar is unstable.

The present disclosure provides an induction motor that includes a conductor cage. The conductor cage includes a plurality of conductor bars buried and disposed in a rotor core in a circumferential direction, and end rings joined with the plurality of conductor bars so as to cause respective both ends thereof to be electrically conducted, in which: each conductor bar includes a first bar-shape metal portion, and two second metal portions joined with both ends of the first metal portion; and the second metal portion is formed in a block shape.

The present disclosure also provides a manufacturing method of an induction motor, the method includes: burring and disposing a plurality of conductor bars in a rotor core in a circumferential direction, each conductor bar including a first bar-shape metal portion, and a second metal portion joined with an end of the first metal portion and formed in a block shape; and assembling a conductor cage by joining end rings with the plurality of conductor bars so as to cause respective both ends thereof to be electrically conducted.

### Other Embodiments

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

For example, in the first embodiment, the length of the first metal portion 17 of the conductor bar 6 is substantially equal to or longer than the length of the slot of the rotor core 4. In addition, in the second embodiment, the length of the first metal portion 17 of the conductor bar 6 is made shorter than the length of the slot of the rotor core 4. In addition to such structures, the length of the first metal portion 17 of the conductor bar 6 may be made longer than the length of the slot of the rotor core 4. This allows the joined portion between the first metal portion 17 and the second metal portion 18 to be disposed in the end ring 5. Hence, shear stress applied to the joined portion between the first metal portion 17 and the second metal portion 18 when the conductor cage 2a rotates can be reduced, thereby suppressing a breakage of the joined portion.

The specific examples were explained with reference to the first and second embodiments, but the dimension of each component and the condition are not limited to the numeric value disclosed in this specification. In addition, even if the material of the end ring 5 and that of the conductor bar 6 are changed without departing from the disclosure as recited in the aforementioned DETAILED DESCRIPTION, the same advantages can be accomplished.

What is claimed is:

1. An induction motor comprising a conductor cage, the conductor cage comprising a plurality of conductor bars buried and disposed in a rotor core in a circumferential direction, and end rings joined with the plurality of conductor bars so as to cause respective both ends thereof to be electrically conducted,
wherein:
each conductor bar comprises a first bar-shape metal portion, and two second metal portions joined with both ends of the first metal portion; and
the second metal portion is formed in a block shape.

2. The induction motor according to claim 1, wherein:
An intermetallic compound is formed between a metal forming the first metal portion and a metal forming the second metal portion; and
the intermetallic compound has a thickness of equal to or smaller than 2 μm.

3. The induction motor according to claim 1, wherein the first metal portion has a length in an axial direction that is substantially equal to or longer than a length of the rotor core in the axial direction.

4. The induction motor according to claim 1, wherein a metal forming the second metal portion and a metal forming the end ring are a same metal or an alloy containing the same metal as a primary component.

5. The induction motor according to claim 1, wherein a metal forming the second metal portion has a melting point equal to or lower than a melting point of a metal forming the end ring.

6. The induction motor according to claim 1, wherein:
a metal forming the second metal portion is aluminum or an aluminum alloy; and
a metal forming the end ring is aluminum or an aluminum alloy.

7. The induction motor according to claim 1, wherein a metal forming the first metal portion has a lower electrical resistance than an electrical resistance of a metal forming the second metal portion.

8. The induction motor according to claim 1, wherein a metal forming the first metal portion is copper or a copper alloy.

9. A manufacturing method of an induction motor, the method comprising:
burring and disposing a plurality of conductor bars in a rotor core in a circumferential direction, each conductor bar comprising a first bar-shape metal portion, and a second metal portion joined with an end of the first metal portion and formed in a block shape; and
assembling a conductor cage by joining end rings with the plurality of conductor bars so as to cause respective both ends thereof to be electrically conducted.

10. The induction motor manufacturing method according to claim 9, further comprising:
joining an end of the first metal portion with the second metal portion in a block shape by friction welding or friction stir welding.

11. The induction motor manufacturing method according to claim 9, wherein assembling the conductor cage includes:
joining and integrating the second metal portion with the end ring by friction stir welding or friction welding.

12. The induction motor manufacturing method according to claim 9, wherein assembling the conductor cage includes:
joining the respective second metal portions of the plurality of conductor bars located at a first end side of the rotor core so as to be electrically conducted by a melted or semi-melted metal forming the end ring.

13. The induction motor manufacturing method according to claim 12, wherein assembling the conductor cage includes die-casting.
